(19) United States
(12) Patent Application Publication
(10) Pub. No.: US 2025/0180294 A1
(43) Pub. Date: Jun. 5, 2025

(54) OVEN OPERATING ACCORDING TO RISK LEVEL, AND CONTROL METHOD THEREFOR

(71) Applicant: SAMSUNG ELECTRONICS CO., LTD., Suwon-si (KR)

(72) Inventors: Jaewoong KIM, Suwon-si (KR); Juneok AHN, Suwon-si (KR); Yunkyeong LEE, Suwon-si (KR); Useong JANG, Suwon-si (KR)

(73) Assignee: SAMSUNG ELECTRONICS CO., LTD., Suwon-si (KR)

(21) Appl. No.: 19/043,905

(22) Filed: Feb. 3, 2025

Related U.S. Application Data
(63) Continuation of application No. PCT/KR2023/016386, filed on Oct. 20, 2023.

(30) Foreign Application Priority Data
Nov. 8, 2022 (KR) 10-2022-0147997

(51) Int. Cl. F27D 21/00; F24C 3/12; F24C 7/08

(52) U.S. Cl. CPC F27D 21/00; F24C 3/128; F24C 7/085; F27D 2021/0057

(57) ABSTRACT

An oven includes a temperature sensor, a memory that stores risk information, including a plurality of risk levels in correspondence with a plurality of temperatures and a plurality of cooking states of the oven. One or more processors identify the risk level of the oven based on the risk information stored in the memory, the risk level corresponding to the cooking state of the oven and the temperature, detected through the temperature sensor, in a cooking chamber of the oven, and control an opening operation of an oven door based on the risk level of the oven, wherein a speed at which the door is opened and a degree to which the door is opened are determined based on the risk level identified by the one or more processors.

### CROSS-REFERENCE TO RELATED APPLICATION

This application is a continuation application is a continuation application, under 35 U.S.C. § 111(a), of international application No. PCT/KR2023/016386, filed Oct. 20, 2023, which claims priority under 35 U. S. C. § 119 to Korean Patent Application No. 10-2022-0147997, filed Nov. 8, 2022, the disclosures of which are incorporated herein by reference in their entireties

### Technical Field

The disclosure relates to an oven operating according to a risk level, and a control method therefor.

### Background Art

In general, cooking appliances may mean various products for cooking food at home or at a restaurant.

An oven among these cooking appliances is a device for performing cooking such as applying heat to a cooking material present in a cooking chamber to boil food. This oven may include a gas oven which combusts a gas to heat the cooking material and an electric oven which uses an electric heater to heat the cooking material.

Meanwhile, a user may open a door of the oven to confirm a state of the cooking material or add seasoning thereto in a cooking process using the oven. In this case, caution of the user is required in that high heat is generated in the oven.

### DISCLOSURE

### Technical Solution

According to an embodiment of the disclosure, an oven includes a temperature sensor, memory to store risk information including a plurality of risk levels in correspondence with a plurality of temperatures and a plurality of cooking states of the oven, and one or more processors. The one or more processors are configured to identify a risk level of the oven, among the plurality of risk levels, corresponding to a cooking state among the plurality of cooking states of the oven and a temperature in a cooking chamber of the oven detected through the temperature sensor based on the risk information stored in the memory. The one or more processors are configured to control an opening operation of a door of the oven based on the risk level of the oven. In this case, a speed at which the door is opened and a degree to which the door is opened are determined based on the risk level identified by the one or more processors.

Also, the one or more processors may identify a recipe mode selected according to a user command among a plurality of recipe modes and identify a risk level corresponding to a cooking state of the oven and a temperature in the cooking chamber detected through the temperature sensor based on risk information corresponding to the recipe mode.

Further, the one or more processors may identify the speed at which the door is opened and the degree to which the door is opened corresponding to the risk level of the oven among opening speeds of the door and opening degrees of the door corresponding to each of a plurality of risk levels and open the door according to the identified opening speed and opening degree.

Also, the one or more processors, based on the risk level of the oven being in a first risk level among the plurality of risk levels, may open the door at a first speed, based on the risk level of the oven being in a second risk level higher than the first risk level among the plurality of risk levels, open the door at a second speed lower than the first speed, based on the risk level of the oven being in a third risk level higher than the second risk level among the plurality of risk levels, open the door only partially, and based on the risk level of the oven being in a fourth risk level higher than the third risk level among the plurality of risk levels, not open the door.

Further, according to an embodiment, the oven may further include a light emitting element, wherein the one or more processors may control the light emitting element to emit a color corresponding to the risk level of the oven among a plurality of different colors corresponding to a plurality of risk levels.

Also, light emitted by the light emitting element may be displayed on door glass of the door.

Further, according to an embodiment, the oven may further include a speaker, wherein the one or more processors, based on the risk level of the oven being equal to or greater than a preset risk level, may output sound through the speaker.

Also, according to an embodiment, the oven may further include a camera, and a speaker, wherein the one or more processors, based on the door being opened and the risk level of the oven being equal to or greater than a preset risk level, may obtain an image where the cooking chamber is photographed by using the camera, and based on a hand of a user without a glove being identified in the obtained image, output sound through the speaker.

According to an embodiment of the disclosure, a method of controlling an oven includes identifying a risk level of the oven corresponding to a cooking state of the oven and a temperature in a cooking chamber of the oven based on risk information, and controlling an opening operation of a door of the oven based on the risk level of the oven, wherein the risk information includes a plurality of risk levels in correspondence with a plurality of temperatures and a plurality of cooking states of the oven, and wherein a speed at which the door is opened and a degree to which the door is opened are determined based on the risk level.

According to an embodiment of the disclosure, a non-transitory computer readable medium storing computer instructions that when executed by one or more processors of the oven, causes the oven to identify a risk level of the oven corresponding to a cooking state of the oven and a temperature in a cooking chamber of the oven based on risk information, and control an opening operation of a door of the oven based on the risk level of the oven, wherein the risk information includes a plurality of risk levels in correspondence with a plurality of temperatures and a plurality of cooking states of the oven, and wherein a speed at which the door is opened and a degree to which the door is opened are determined based on the risk level.

### DESCRIPTION OF DRAWINGS

FIGS. 1A and 1B are views illustrating an oven according to an embodiment;

FIG. 2 is a block diagram illustrating a configuration of an oven according to an embodiment;

FIGS. 3A and 3B are views illustrating risk information according an embodiment;

FIGS. 4A and 4B are views illustrating a method of controlling a door according to a risk level according to an embodiment;

FIG. 5 is a view illustrating an example of emitting light through a light emitting element according to a risk level according to an embodiment;

FIG. 6 is a view illustrating an example of outputting sound according to a risk level according to an embodiment;

FIG. 7 is a view illustrating a method of outputting sound based on a hand detected in an oven according to a risk level according to an embodiment;

FIG. 8 is a block diagram illustrating a detailed configuration of an oven according to an embodiment; and

FIG. 9 is a flow chart illustrating a method of controlling an oven according to an embodiment.

### MODE FOR INVENTION

Embodiments of the disclosure may be modified in various different forms and may have various embodiments, wherein specific embodiments will be exemplified in the drawings and specifically explained in the detailed description. However, it should be noted that the various embodiments are not for limiting the scope of the disclosure to a specific embodiment but they should be interpreted to include all modifications, equivalents, and/or alternatives of the embodiments of the disclosure. With respect to the description of the drawings, similar components may be designated by similar reference numerals.

In case it is determined that in describing the disclosure, the detailed description of related known functions or configurations may unnecessarily confuse the gist of the disclosure, the detailed description thereof will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain specific embodiments and are not intended to limit the scope of the disclosure. A singular expression includes a plural expression, unless obviously differently defined in the context.

In the disclosure, the expression such as “have,” “may have,” “include”, or “may include” denotes the existence of such a characteristic (e.g. a numerical value, a function, an operation, or a component such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expression “1st”, “2nd”, “first”, “second”, or the like used in the disclosure may be used to describe various elements regardless of any order and/or degree of importance, wherein the expression is used only to distinguish one element from another element and is not intended to limit the elements.

Meanwhile, the description that one element (e.g. a first element) is “(operatively or communicatively) coupled with/to” or “connected to” another element (e.g. a second element) should be interpreted such that the one element is directly coupled to the another element, or the one element is coupled to the another element through the other element (e.g. a third element).

In contrast, the description that one element (e.g. a first element) is “directly coupled” or “directly connected” to another element (e.g. a second element) may be interpreted to mean that the other element (e.g. a third element) is not present between the one element and the another element.

The expression “configured to” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean that a device is “specifically designed to” do in terms of hardware.

Instead, under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g. an embedded processor), or a generic-purpose processor that may perform the corresponding operations by executing one or more software programs stored in a memory device (e.g. a CPU or an application processor).

In embodiments of the disclosure, a ‘module’ or ‘part’ may perform at least one function or operation and may be implemented as hardware or software, or as a combination of hardware and software. Also, a plurality of ‘modules’ or ‘parts’ may be integrated into at least one module and implemented as at least one processor, excluding ‘module’ or ‘part’ that needs to be implemented as specific hardware.

Meanwhile, various elements and areas in the drawings are illustrated schematically. Accordingly, the technical idea of the disclosure is not limited by the relative sizes or intervals illustrated in the appended drawings.

Hereinafter, with reference to the appended drawings, an embodiment according to the disclosure is specifically described to be easily embodied by those skilled in the art.

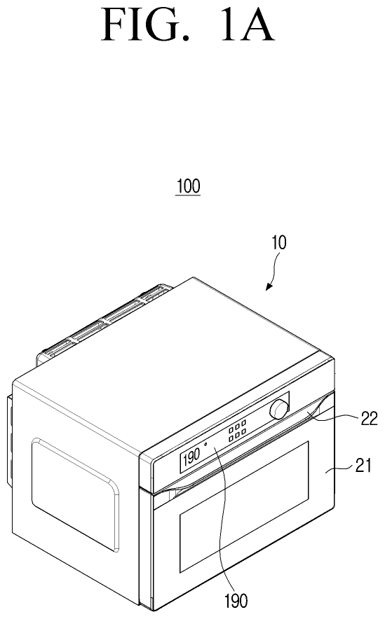

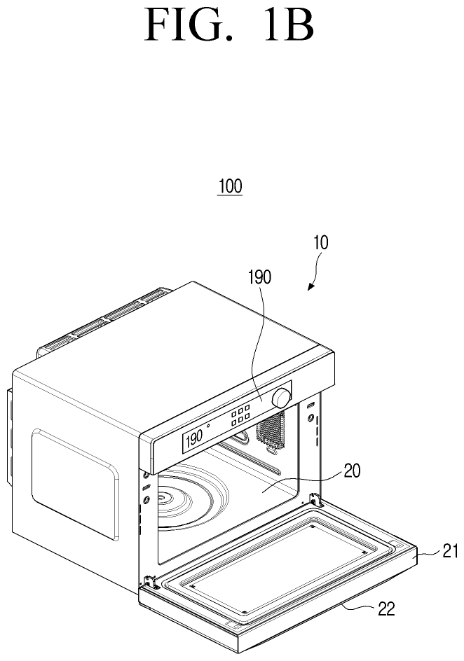

FIGS. 1A and 1B are views illustrating an oven according to an embodiment.

With reference to FIGS. 1A and 1B, an oven 100 includes a main body 10 forming an appearance. Also, a receiving space opened toward one side may be prepared inside the oven 100.

Here, the receiving space of the main body 10 may be a cooking chamber 20 for cooking a cooking material (i.e. food). The cooking chamber 20 is formed in a box shape, and its front surface is opened to put the cooking material therein or remove it therefrom.

The front surface of the cooking chamber 20 may be opened or closed by a door 21 connected to the main body 10. For the above, the door 21 may be coupled to be rotatable with respect to the main body 10 by a hinge. Also, a door handle 22 is prepared on the door 21, and a user may open and close the cooking chamber 20 by griping the door handle 22.

Also, the oven 100 may include a heater (e.g. an electric heater) for heating the cooking material in the cooking chamber 20 and a pan for circulating air in the cooking chamber 20.

An input interface 190 is prepared on the main body 10. The input interface 190 may receive a user command for controlling an operation of the oven 100.

For the above, the input interface 190 may include a button for receiving the user command. For example, the button may include an auto door button. The oven 100, if the user command to select the auto door button is received, may drive a motor to open the door 21. Accordingly, the door 21 may be automatically opened.

Meanwhile, the oven 100 may determine a risk level based on a cooking state of the oven 100 and a temperature in the cooking chamber 20 and control an operation of the oven 100 based on the risk level. For example, the oven 100, if the user command to select the auto door button is received, may open the door 21 at a slow speed, open the door 21 only partially, or not open the door 21 according to the risk level of the oven 100. Also, the oven 100 may output at least one of light having a specific color or sound according to the risk level of the oven 100.

Accordingly, the user may prevent an accident which may occur to the user in a process in which the user uses the oven 100.

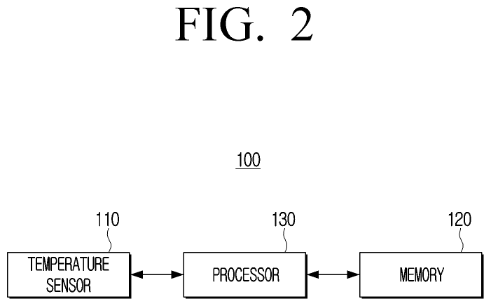

FIG. 2 is a block diagram illustrating a configuration of an oven according to an embodiment.

With reference to FIG. 2, the oven 100 may include a temperature sensor 110, memory 120, and one or more processors 130.

The temperature sensor 110 may detect a temperature in the cooking chamber 20. For the above, the temperature sensor 110 may be positioned in the cooking chamber 20.

The memory 120 may store risk information. Here, the risk information may include information about a risk level at each of a plurality of temperatures for each of a plurality of cooking states.

The one or more processors 130 may be electrically connected to the temperature sensor 110 and memory 120 to control the operations and functions of the oven 100 overall.

The one or more processors 130 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 130 may control one combination or any combination of other components of the oven 100 and perform an operation related to communication or data processing. The one or more processors 130 may perform one or more programs or instructions stored in the memory. For example, the one or more processors 130 may perform a method according to an embodiment of the disclosure by executing one or more instructions stored in the memory.

Meanwhile, if a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor).

The one or more processors 130 may be implemented as a single core processor including one core and may be implemented as one or more multi core processors including a plurality of cores (e.g. homogeneous multicores or heterogeneous multicores). If the one or more processors 130 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor, and the third operation may be performed by the second core included in the multi core processor.

In embodiments of the disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, a machine learning accelerator, or the like but embodiments of the disclosure are not limited thereto.

Hereinafter, one or more processors 130 are referred to as a processor 130.

The processor 130 may open a door 21 based on a user command. For the above, the oven 100 may include a motor to open the door 21.

Specifically, the processor 130, if the user command to open the door 21 is received, may drive the motor to open the door 21. Here, the user command may be inputted through a button (e.g. an auto door button) prepared on the input interface 190. Accordingly, the door 21 of the oven 100 may be automatically opened.

Meanwhile, the processor 130 identifies a risk level of the oven 100. Here, the risk level (or a risk grade) may be one of a plurality of risk levels.

For example, the plurality of risk levels may include a risk level from level 0 to level 5.

Here, the risk level 0 may mean a state in which the user is not in danger even if the door 21 is opened. Also, the risk level 1 may mean a state in which the user needs to be careful a bit if the door 21 is opened. Also, the risk level 2 may mean a state in which the user needs to be careful if the door 21 is opened. Also, the risk level 3 may mean a state in which the user may be in danger depending on a condition of the user (e.g. an age or a degree of proficiency of the user) if the door 21 is opened. Also, the risk level 4 may mean a state in which most users may be in danger of having an accident if the door 21 is opened. Also, the risk level 5 may mean a state in which the user may be exposed to serious danger if the door 21 is opened because a temperature in the oven 100 is so high, so that the door 21 should never be opened.

As the above, the risk level may mean that a degree of danger, which the user may run into due to opening of the door 21 is divided according to a stage. Meanwhile, in the aforementioned example, the description is made such that the risk level is divided into 6 stages. Meanwhile, the risk level may be divided into more than or fewer than 6 levels.

Specifically, the processor 130 identifies a risk level of the oven corresponding to a cooking state of the oven 100 and a temperature in the cooking chamber 20 detected through the temperature sensor 110 based on risk information stored in the memory 120.

For the above, the processor 130 may obtain a temperature in the cooking chamber 20 detected by the temperature sensor 110.

Also, the processor 130 may identify a cooking state of the oven 100. Here, the cooking state of the oven 100 may mean an operation state of the oven 100 related to cooking of a cooking material. For example, the cooking state of the oven 100 may be one of “before cooking”, “during preheating”, “during cooking”, and “after cooking completion”.

Specifically, the oven 100 may include a plurality of modes. The plurality of modes may include a manual mode and an auto mode.

The manual mode may mean a mode for performing cooking according to a cooking temperature, a cooking time, and a cooking mode (e.g. the cooking mode may include a direct fired oven, an oven, an air fryer, a grill, or the like, wherein as an example, according to the cooking mode, at least one of whether to drive a pan, a direction in which air flows in the cooking chamber 20, or a rotation speed of the pan may be determined) set by a user command.

For example, the user may set a cooking temperature, a cooking time, and a cooking mode through the input interface 190 and may select a start button. In this case, the processor 130 may drive a heater and a pan to heat a cooking material according the cooking temperature and the cooking mode set by the user command and provide hot air to the cooking material, thereby performing cooking during the cooking time set by the user command. Further, the processor 130 may stop driving the heater and pan and complete cooking if the cooking time is elapsed.

The auto mode may mean a mode that the oven 100 automatically sets a cooking temperature, a cooking time, and a cooking mode and performs cooking. Specifically, the auto mode may include a plurality of recipe modes. Further, the memory 120 may store information about a preset cooking temperature, cooking time, and cooking mode with respect to each recipe mode.

For example, the user may select one among a plurality of recipe modes through the input interface 190 after putting ingredients of food prepared according to a recipe to the cooking chamber 20. In this case, the processor 130 may identify a cooking temperature, a cooking time, and a cooking mode corresponding to a recipe mode selected according to the user command by using information about a cooking temperature, a cooking time, and a cooking mode for each of the plurality of recipe modes stored in the memory 120. Further, the processor 130 may drive a heater and a pan to heat a cooking material according to the identified cooking temperature and the identified cooking mode and provide hot air to the cooking material, thereby performing cooking during the identified cooking time. Further, the processor 130 may stop driving the heater and pan and complete cooking if the cooking time is elapsed. Meanwhile, the processor 130 may determine a cooking state of the oven 100.

For example, the processor 130, if a user command to select a cooking start and a recipe mode is not inputted, may identify a cooking state of the oven 100 as “before cooking”.

Also, the processor 130, if a time section is in a time section from a time point when a user input to select a cooking start or a recipe mode is inputted to the oven 100 to a time point when a temperature in the cooking chamber 20 arrives at a preset temperature or a time point when a preset time is elapsed, may identify a cooking state of the oven 100 as “during preheating”.

Here, in the case of the manual mode, the preset temperature and the preset time may be set to be determined based on a cooking temperature and a cooking time inputted by the user command. In the case of the auto mode, the preset temperature and the preset time may be set to be determined based on a cooking temperature and a cooking time corresponding to a recipe mode.

Also, the processor 130, if the time section is in a time section from a time point when preheating is completed to a time point when cooking is completed, may identify a cooking state of the oven 100 as “during cooking”.

Also, the processor 130, if the cooking time is elapsed and the cooking is completed, may identify a cooking state of the oven 100 as “after cooking completion”.

Further, the processor 130 identifies a risk level of the oven 100 corresponding to a cooking state of the oven 100 and a temperature in the cooking chamber 20 based on risk information stored in the memory 120.

For the above, the memory 120 may store risk information. Here, the risk information may include information about a risk level at each of a plurality of temperatures for each of a plurality of cooking states.

In this case, the memory 120 may store a plurality of risk information for the manual mode and a plurality of risk information for the auto mode.

The plurality of risk information for the manual mode may correspond to a plurality of cooking modes. That is, risk information corresponding to each cooking mode may be stored in the memory 120.

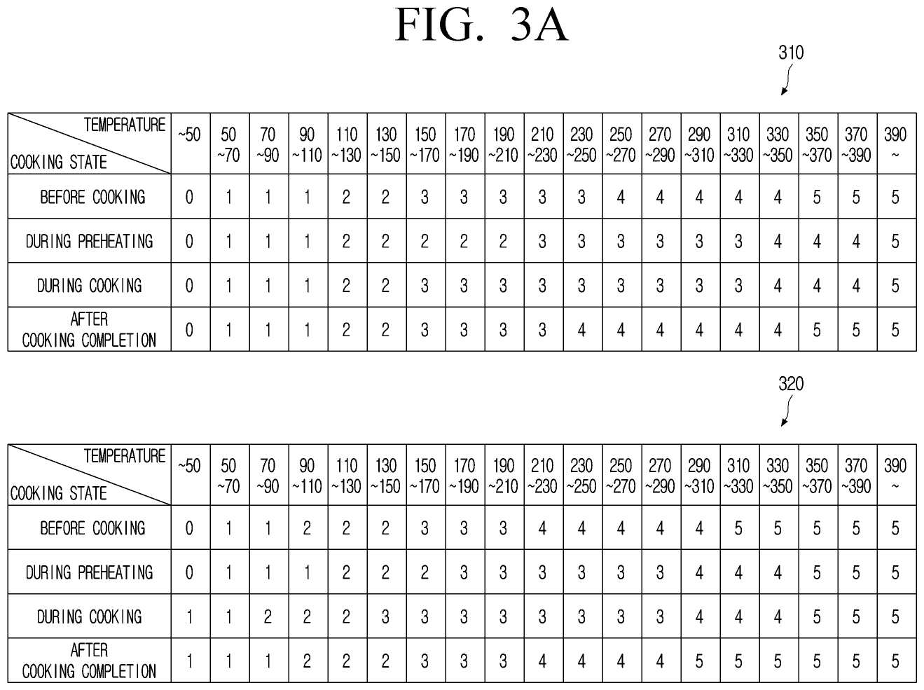

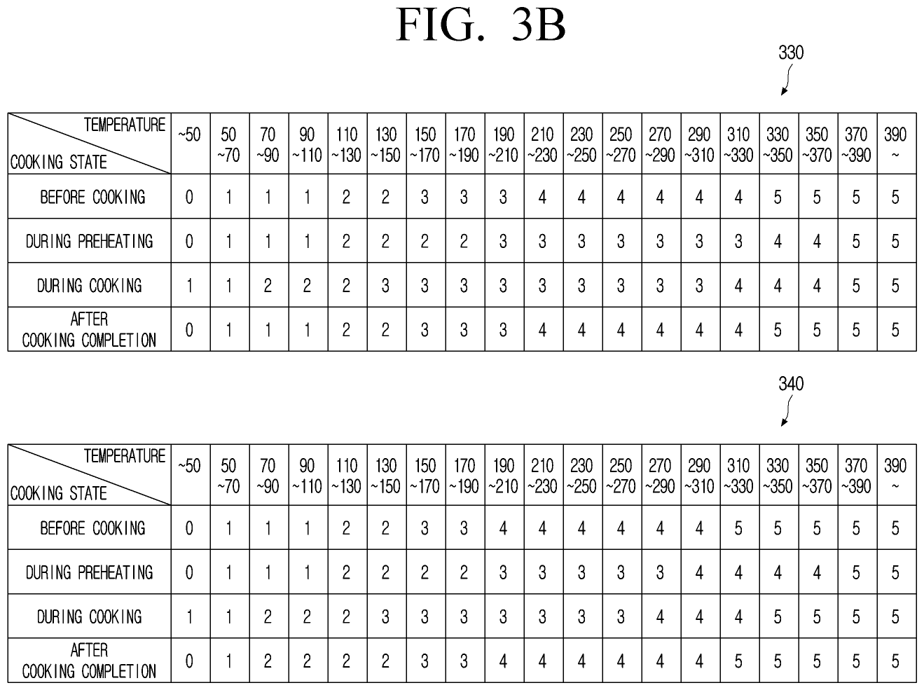

For example, as shown in 3A, risk information 310 corresponding to cooking mode 1 and risk information 320 corresponding to cooking mode 2 may be stored. As shown in 3A, risk information 310, 320 may include information about a risk level according to a temperature in the cooking chamber 20 in each cooking state when the cooking state of the oven 100 corresponds to each of “before cooking”, “during preheating”, “during cooking”, and “after cooking completion”. Meanwhile, it is described in FIG. 3A that two risk information for the manual mode is stored in the memory 120, but the description is merely an example. That is, the risk information for the manual mode may be more than or fewer than two depending on a cooking mode provided by the oven 100.

The processor 130 may identify a recipe mode selected according to a user command among a plurality of recipe modes and identify a risk level corresponding to a cooking state of the oven 100 and a temperature in the cooking chamber 20 detected through the temperature sensor 110 based on risk information corresponding to the identified recipe mode.

That is, in the case of the manual mode, the cooking mode may be selected according to the user command. In this case, the processor 130 may identify risk information corresponding to a cooking mode selected according to a user command among the plurality of risk information for the manual mode stored in the memory 120 and identify a risk level corresponding to a cooking state of the oven 100 and a temperature in the cooking chamber 20 among risk levels at each of a plurality of temperatures for each of a plurality of cooking states based on risk information.

For example, it is assumed that the cooking mode selected according to the user command is in the cooking mode 2, the oven 100 is in a state of preheating, and a temperature in the cooking chamber 20 detected by the temperature sensor 110 is 95° C. In this case, with reference to FIG. 3A, the processor 130 may identify that the risk level of the oven 100 is in the risk level 1 based on risk information 320 corresponding to the cooking mode 2.

A plurality of risk information for the auto mode may correspond to a plurality of recipe modes. That is, risk information corresponding to each recipe mode may be stored in the memory 120.

For example, as shown in 3B, risk information 330 corresponding to recipe mode 1 and risk information 340 corresponding to recipe mode 2 may be stored. As shown in FIG. 3B, the risk information 330, 340 may include information about a risk level according to a temperature in the cooking chamber 20 in each cooking state when the cooking state of the oven 100 corresponds to each of “before cooking”, “during preheating”, “during cooking”, and “after cooking completion”. Meanwhile, it is described in FIG. 3B that two risk information for the auto mode is stored in the memory 120, but the description is merely an example. That is, the risk information for the auto mode may be more than or fewer than two depending on a recipe mode provided by the oven 100.

The processor 130 may identify a recipe mode selected according to a user command among a plurality of recipe modes and identify a risk level corresponding to a cooking state of the oven 100 and a temperature in the cooking chamber 20 detected through the temperature sensor 110 based on risk information corresponding to the recipe mode.

That is, in the case of the auto mode, the recipe mode may be selected according to the user command. In this case, the processor 130 may identify risk information corresponding to a recipe mode selected according to a user command among the plurality of risk information for the auto mode stored in the memory 120 and identify a risk level corresponding to a cooking state of the oven 100 and a temperature in the cooking chamber 20 among risk levels at each of a plurality of temperatures for each of a plurality of cooking states based on risk information.

For example, it is assumed that the cooking mode selected according to the user command is in the recipe mode 1, the oven 100 is in a state of “after cooking completion”, and a temperature in the cooking chamber 20 detected by the temperature sensor 110 is 355° C. In this case, with reference to FIG. 3B, the processor 130 may identify that the risk level of the oven 100 is in the risk level 5 based on risk information 330 corresponding to the recipe mode 1.

Meanwhile, the processor 130 controls an opening operation of the door 21 of the oven 100 based on the risk level of the oven 100.

Specifically, the processor 130, if the user command to open the door 21 is received through the input interface 190, may open the door 21. Here, the user command may be inputted through a button (e.g. an auto door button) prepared on the input interface 190.

Here, the processor 130 may control an opening operation of the door 21 of the oven 100 based on the risk level of the oven 100. In this case, a speed at which the door 21 is opened and a degree to which the door 21 is opened may be determined based on the risk level.

Specifically, the processor 130 may identify an opening speed of the door 21 and an opening degree of the door 21 corresponding to a risk level of the oven 100 among opening speeds of the door 21 and opening degrees of the door 21 corresponding to each of a plurality of risk levels. Further, the processor 130 may open the door 21 according to the identified opening speed and opening degree.

Further, information about an opening speed and an opening degree of the door 21 corresponding to each of the plurality of risk levels may be stored in the memory 120. Accordingly, the processor 130 may identify an opening speed and an opening degree of the door 21 corresponding to a risk level of the oven 100 among the plurality of risk levels by using information stored in the memory 120. Further, the processor 130 may control an opening speed and an opening degree of the door 21 by using a motor.

Specifically, the processor 130, if the risk level of the oven 100 is in a first level among the plurality of risk levels, may open the door 21 at a first speed. Further, the processor 130, if the risk level of the oven 100 is in a second risk level higher than the first risk level among the plurality of risk levels, may open the door 21 at a second speed lower than the first speed.

Here, the first risk level may be a low risk level among the plurality of risk levels. For example, the first risk level may be the risk level 0 and the risk level 1. Further, the second risk level may be an intermediate risk level among the plurality of risk levels. For example, the second risk level may be the risk level 2 and the risk level 3.

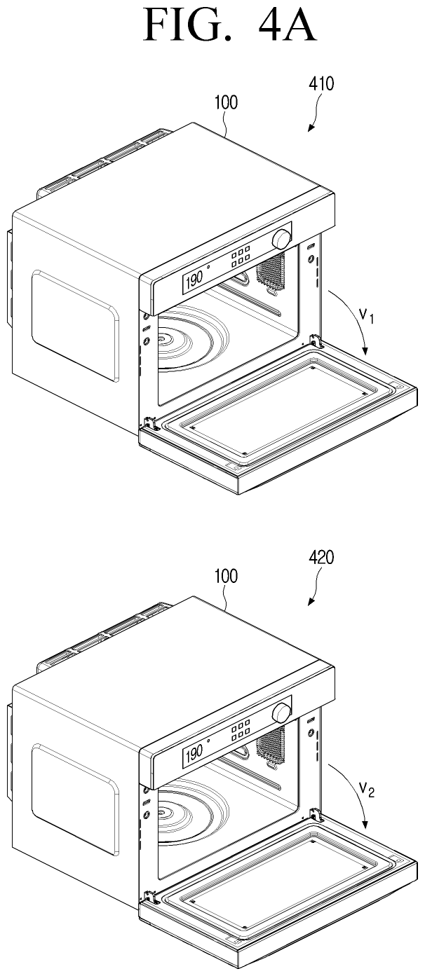

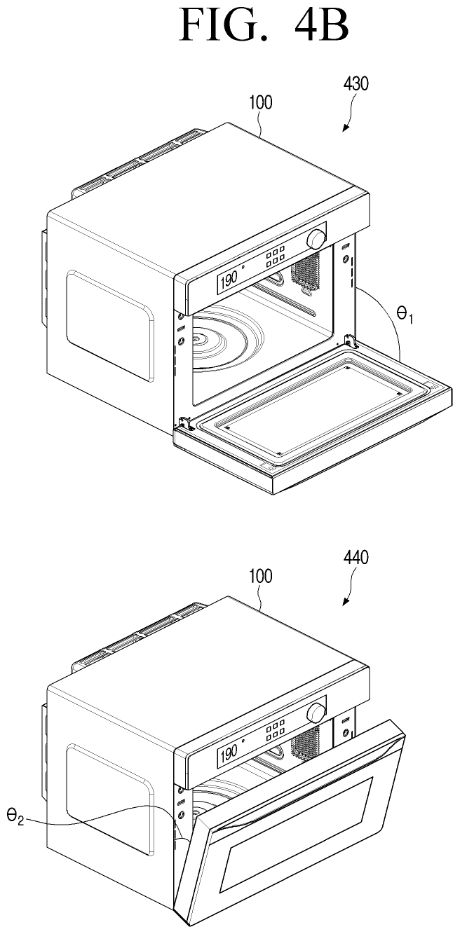

Accordingly, with reference to 410 of FIG. 4A, if the risk level of the oven 100 is in the first risk level, the door 21 may be automatically opened at a speed of v₁. Accordingly, with reference to 420 of FIG. 4A, if the risk level of the oven 100 is in the second risk level, the door 21 may be automatically opened at a speed of v₂. Here, v₁ is greater than v₂, so that if the risk level of the oven 100 is in the second risk level, the door 21 may be more slowly opened compared to a case that the risk level of the oven 100 is in the first risk level.

Also, the processor 130, if the risk level of the oven 100 is in a third risk level higher than the second risk level among the plurality of risk levels, may open the door 21 only partially.

Here, the third risk level is a high risk level among the plurality of risk levels. For example, the third risk level may be the risk level 4.

For example, with reference to 430 of FIG. 4B, if the risk level of the oven 100 is in the first risk level and the second risk level, the door 21 may be completely opened.

That is, the door 21 may open and close the cooking chamber 20 in a method that an upper part of the door 21 rotates around a lower part of the door 21. Here, a state that the door 21 is completely opened may mean a state that the door 21 rotates approximately 90 (=θ₁) degrees with respect to a state that door 21 is closed. Meanwhile, even if the user manually opens the door 21, the door 21 may be completely opened. Meanwhile, this is an example, and an angle by which the door 21 rotates when the door 21 is completely opened may be set in a process of manufacturing the oven 100.

Meanwhile, with reference to 440 of FIG. 4B, if the risk level of the oven 100 is in the third risk level, the door 21 may be opened only partially (e.g. the door 21 may be opened by 10 cm). Here, the state that the door 21 is opened only partially may mean a state that the door 21 rotates by a preset angle (θ₂) and then, stops. Here, the preset angle may be an angle of approximately 15 degrees or less. Meanwhile, this is an example, and an angle by which the door 21 rotates may be set as various values in a process of manufacturing the oven 100.

That is, if the risk level of the oven 100 is high, the door 21 rotates by a preset angle and is positioned to be inclined with respect to a virtual plane corresponding to a front surface of the cooking chamber 20. In this regard, the cooking chamber 20 is not completely opened by the door 21.

Also, the processor 130, if the risk level of the oven 100 is in a fourth risk level higher than the third risk level among the plurality of risk levels, may not open the door 21.

Here, the fourth risk level is the highest risk level among the plurality of risk levels. For example, the fourth risk level may be the risk level 5.

That is, if a risk level of the oven 100 is the highest, even though a user command to open the door 21 is inputted, the door 21 may not be opened and be maintained in a closed state.

Meanwhile, the oven 100 may include a light emitting element. Here, the light emitting element may emit light having a plurality of colors. For example, the light emitting element may be a LED lamp.

The processor 130 may control the light emitting element to emit a color corresponding to a risk level of the oven 100 among a plurality of different colors corresponding to the plurality of risk levels.

For example, the processor 130 may control the light emitting element to emit white light if the risk level of the oven 100 is in the risk level 0. Also, the processor 130 may control the light emitting element to emit yellow light if the risk level of the oven 100 is in the risk level 1. Also, the processor 130 may control the light emitting element to emit slight orange light if the risk level of the oven 100 is in the risk level 2. Also, the processor 130 may control the light emitting element to emit orange light if the risk level of the oven 100 is in the risk level 3. Also, the processor 130 may control the light emitting element to emit slight red light if the risk level of the oven 100 is in the risk level 4. Also, the processor 130 may control the light emitting element to emit red light if the risk level of the oven 100 is in the risk level 5.

Meanwhile, light emitted by the light emitting element may be displayed on door glass of the door 21. The door glass may have a rectangular shape and may be implemented as a glass material. The light emitting element may be positioned at a lower part of the door glass such that light emitted from the light emitting element is directed to the door glass. Accordingly, a color of light emitted by the light emitting element may be displayed on the door glass.

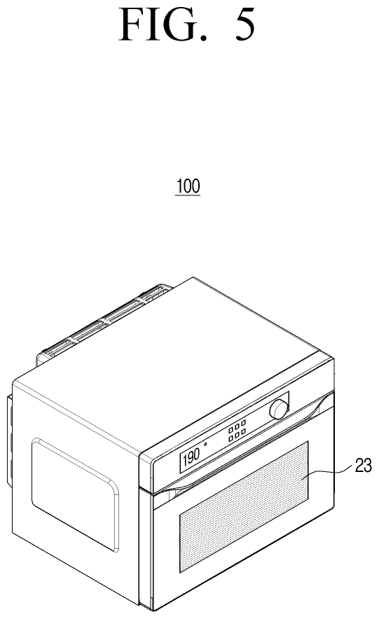

For example, as shown in FIG. 5, the processor 120 may control the light emitting element to emit red light if the risk level of the oven 100 is in the risk level 5. Accordingly, red may be displayed on the door glass 23.

Meanwhile, the oven 100 may include a speaker. In this case, the processor 130, if the risk level of the oven 100 is equal to or greater than a preset risk level, may output sound through the speaker.

Here, the preset risk level is the highest risk level among the plurality of risk levels. For example, the preset risk level may be the risk level 4.

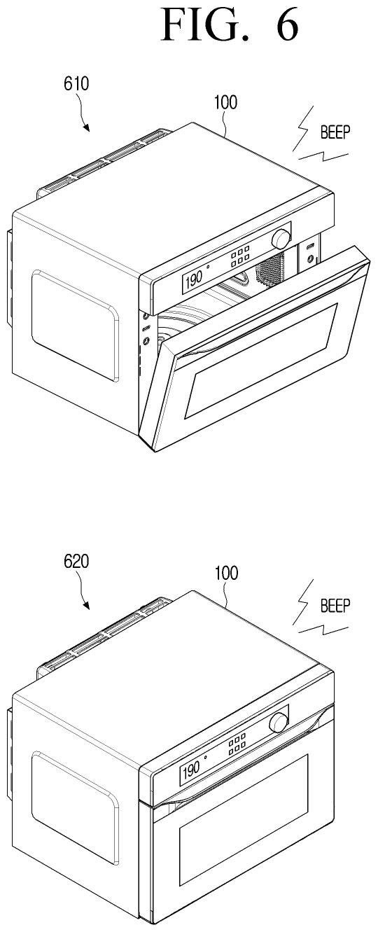

As shown in 610 of FIG. 6, the processor 120, if the risk level of the oven 100 is in the risk level 4, may output warning sound (or an alarm) through the speaker. For example, as shown in 620 of FIG. 6, the processor 120, if the risk level of the oven 100 is in the risk level 5, may output warning sound (or an alarm) through the speaker.

As above, the oven 100 may determine a risk level of the oven 100 based on a cooking state of the oven 100 and a temperature in the cooking chamber 20. Further, the oven 100, when automatically opening the door 21, may open the door 21 at a slow speed, open it only partially, or not open it based on the risk level of the oven 100. Also, the oven 100 may output at least one of light having a specific color or sound according to the risk level of the oven 100.

For example, if a cooking material is being cooked in the oven 100, there is a risk that a safety accident occurs to the user due to a dangerous element (e.g. hot oil, etc.) incurred from the cooking material depending on a high temperature inside the oven, a type of material, and the like, but the user may approximately recognize this risk because the oven 100 is driven. However, after the cooking is completed, the user may not recognize this risk because the oven 100 is not driven even though there is no cooking material in the oven 100 and a temperature inside the oven is still high. However, there are many cases that the user wants to open the door and directly confirm the cooking material during cooking or after cooking completion.

Therefore, the oven 100 of the disclosure determines a risk level based on a cooking state of the oven 100 and a temperature in the cooking chamber 20, controls an opening operation of the door 21 according to the risk level, and provides a notification to the user. Accordingly, an accident which may occur to the user under various circumstances may be prevented.

Also, the oven 100 may photograph the cooking chamber 20 according to a risk level of the oven 100 and may output sound based on an image in which the cooking chamber 20 is photographed. For the above, the oven 100 may include a camera and a speaker. In this case, the camera may be positioned in the oven 100 and photograph the cooking chamber 20.

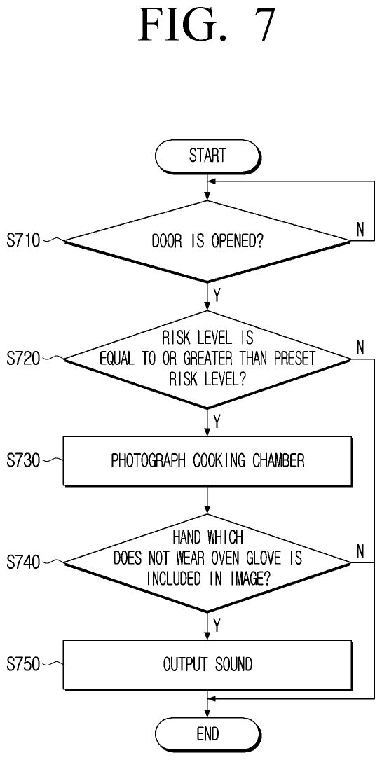

Specifically, with reference to FIG. 7, the processor 120, if the door 21 is opened (S710-Y) and the risk level of the oven 100 is equal to or greater than a preset risk level (S720-Y), may obtain an image in which the cooking chamber 20 is photographed by using the camera (S730).

Here, a case that the door 21 is opened may include a case that the door 21 is automatically opened according to a user command and a case that the user manually opens the door 21. For the above, the oven 100 may include a sensor for detecting whether the door 21 is opened or closed. In this case, the processor 130 may identify whether the door 21 is opened by using the sensor.

Further, the preset risk level is a high level among the plurality of risk levels. For example, the preset risk level may be the risk level 4.

For example, the processor 130, if the risk level of the oven 100 is in the risk level 4, may open the door 21 only partially. In this case, the processor 130 may control the camera to photograph an image and obtain the image in which the cooking chamber 20 is photographed from the camera.

For example, the processor 130, if the risk level of the oven 100 is in the risk level 5, may not open the door 21. Here, it is assumed that the user manually opens the door 21. In this case, the processor 130 may control the camera to photograph an image and obtain the image in which the cooking chamber 20 is photographed from the camera.

Further, the processor 130 may identify whether a hand which does not wear an oven glove is included in the image (S740).

In this case, the processor 130 may input the image into an AI model to identify whether the hand which does not wear the oven glove is included in the obtained image. Here, the AI model may be a model trained to identify the hand which does not wear the oven glove. In this case, the AI model may be trained by deep learning.

Accordingly, the processor 130 may input the image into the AI model to identify whether the hand which does not wear the oven glove is included in the image based on an output of the AI model. Here, the AI model may be stored in the memory 120.

Further, the processor 130, if the hand which does not wear the oven glove is included in the image (S740-N), may output sound through the speaker (S750). Here, sound may be warning sound or alarm sound.

For example, if the user puts a hand in the oven where its temperature is high in a state that the user does not wear an oven glove, the user may have a burn, etc. Accordingly, the oven of the disclosure, if the user puts a hand in the oven in the state that the user does not wear the oven glove, may output sound by using a risk level determined according to a cooking state of the oven 100 and a temperature of the cooking chamber 20 to prevent an accident.

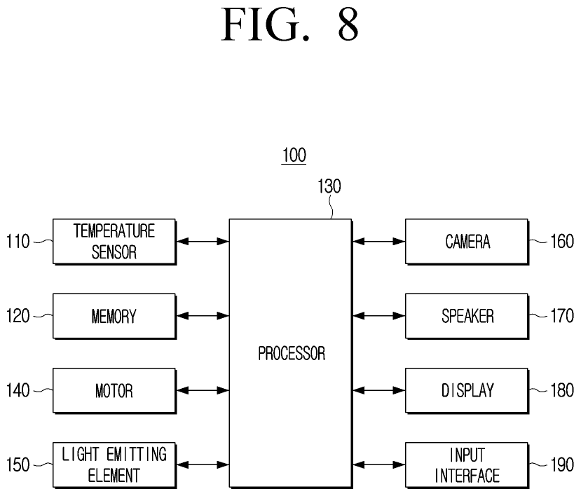

FIG. 8 is a block diagram illustrating a detailed configuration of an oven according to an embodiment.

With reference to FIG. 8, the oven 100 may include a temperature sensor 110, memory 120, a processor 130, a motor 140, a light emitting element 150, a camera 160, a speaker 170, a display 180, and an input interface 190. However, the above configurations are merely exemplary, wherein it is obvious that upon implementing the disclosure, a new configuration may be added to the above configurations, or part of the configurations may be omitted. Meanwhile, in describing FIG. 8, part overlapped with the part described in FIGS. 1 to 7 is omitted or concisely described.

The memory 120 may store various data related to an operation and a function of the oven 100. For example, the memory 120 may store risk information. Also, information about an opening speed and an opening degree of the door 21 corresponding to each of a plurality of risk levels may be stored in the memory 120. Also, the memory 120 may store information about a preset cooking temperature, cooking time, and cooking mode with respect to each recipe mode. Also, the memory 120 may store an AI model.

Also, the memory 120 may store at least one instruction related to the oven 100. Further, the memory 120 may store various software programs or applications in order that the oven 100 operates according to various embodiments of the disclosure. Also, the memory 120 may store various software modules for operating the oven 100 according to various embodiments of the disclosure, and the processor 130 may execute various software modules stored in the memory 120 to control an operation of the oven 100.

In this case, the memory 120 may include volatile memory such as a frame buffer, semiconductor memory such as flash memory, or magnetic storage media such as a hard disk.

The motor 140 may open the door 21. For example, the motor 140 may transfer power to the door 21 to open the door 21. In this case, the processor 130, if the user command to open the door 21 is received through the input interface 190, may drive the motor 140 to open the door 21. Accordingly, the door 21 may be automatically opened.

The light emitting element 150 may emit light. In this case, the light emitting element 150 may emit light having various colors. The processor 130 may control the light emitting element 150 to emit light having a color corresponding to a risk level of the oven 100. In this case, the light emitting element 150 may be positioned at a lower part of the door glass of the door 21. Accordingly, the color of the light emitted by the light emitting element 150 may be displayed on the door glass.

The camera 160 may generate an image through photographing. Here, the camera 160 may be installed in the oven 100 to photograph the cooking chamber 20. In this case, the processor 130 may obtain an image by using the camera 160 and identify whether the hand which does not wear the oven glove is included in the image.

The speaker 170 may output sound. Specifically, the processor 130 may output various sound related to an operation of the oven 100 through the speaker 170. For example, the processor 130 may output warning sound through the speaker 170 according to a risk level of the oven 100. Also, the processor 130, if identifying that the hand which does not wear the oven glove is included in the image obtained through the camera 160, may output warning sound through the speaker 170.

The display 180 may display various information. For the above, the display 1870 may be implemented as a Liquid Crystal Display (LCD), etc. Specifically, the processor 130 may display information related to an operation of the oven 100 on the display 180.

The input interface 190 may include circuitry. The input interface 190 may receive a user command. For the above, the input interface 190 may include a button, a dial, etc.

For example, the input interface 190 may receive a user command for opening the door 21, a user command related to cooking of the oven 100 (e.g. a cooking temperature, a cooking time, a cooking mode, a recipe mode, etc.), etc.

Further, the input interface 190 may transfer the inputted user command to the processor 130. In this case, the processor 130, if the user command is received through the input interface 190, may control an operation of the oven 100 based on the received user input.

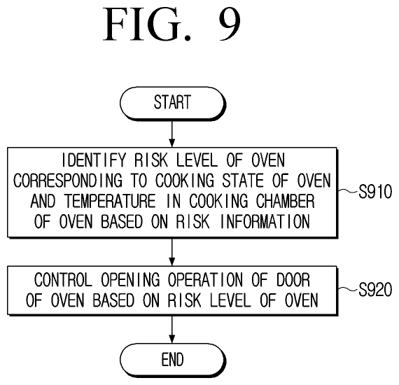

FIG. 9 is a flow chart illustrating a method of controlling an oven according to an embodiment.

In advance, the method includes identifying a risk level of the oven corresponding a cooking state of the oven and a temperature in a cooking chamber of the oven based on risk information (S910). Here, the risk information may include information about a risk level at each of a plurality of temperatures for each of a plurality of cooking states.

Further, the method includes controlling an opening operation of a door of the oven based on the risk level of the oven (S920). Here, a speed at which the door is opened and a degree to which the door is opened are determined based on the risk level.

Specifically, in the step S910, the method may include identifying a recipe mode selected according to a user command among a plurality of recipe modes and identifying a risk level corresponding to a cooking state of the oven and a temperature in the cooking chamber based on risk information corresponding to the recipe mode.

Also, in the step S920, the method may include identifying an opening speed of the door and an opening degree of the door corresponding to the risk level of the oven among speeds of the door and opening degrees of the door corresponding to each of a plurality of risk levels, and opening the door according to the identified opening speed and opening degree.

Also, in the step S920, the method may include, if the risk level of the oven is in a first risk level among a plurality of risk levels, opening the door at a first speed and if the risk level of the oven is in a second risk level higher than the first risk level among the plurality of risk levels, opening the door at a second speed lower than the first speed. Also, in the step S920, the method may include, if the risk level of the oven is a third risk level higher than the second risk level among the plurality of risk levels, opening the door only partially. Also, in the step S920, the method may include, if the risk level of the oven is in a fourth risk level higher than the third risk level among the plurality of risk levels, not opening the door.

Meanwhile, a color corresponding to the risk level of the oven among different colors corresponding to the plurality of risk levels may be emitted by using a light emitting element.

Here, light emitted by the light emitting element may be displayed on door glass of the door.

Also, the method may include, if the risk level of the oven is equal to or greater than a preset risk level, outputting sound.

Further, the method may include, if the door is opened and the risk level of the oven is equal to or greater than the preset risk level, obtaining an image in which the cooking chamber is photographed and if a hand of a user who does not wear an oven glove is identified in the obtained image, outputting sound.

Meanwhile, according to an embodiment, a method according to examples of the disclosure may be provided to be included in a computer program product. The computer program product may be traded between a seller and a buyer as goods. The computer program product may be distributed in a form of the machine-readable storage medium (e.g. compact disc read only memory (CD-ROM)) or on-line distributed (e.g. downloaded or uploaded) via an application store (e.g. play store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server.

As aforementioned, each of the components (e.g. a module or a program) according to the various embodiments of the disclosure as above may be configured as a single item or a plurality of items, wherein partial subcomponents of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration.

According to various embodiments, operations performed by a module, a program, or another component may be executed sequentially, in parallel, repetitively, or heuristically, at least part of the operations may be executed in different orders or be omitted, or another operation may be added.

Meanwhile, the term “part” or “module” used in the disclosure may include a unit configured of hardware, software, or firmware and may be interchangeably used with the term, for example, logic, a logic block, a part, a circuit, or the like. The term “part” or “module” may be an integrally configured component or a minimum unit or its part performing one or more functions. For example, the module is configured as an application-specific integrated circuit (ASIC).

Meanwhile, a non-transitory computer readable medium storing a program sequentially performing a control method according to the disclosure may be provided. The non-transitory readable medium does not mean a medium that stores data for a short time such as a resistor, a cache, memory, or the like but a machine readable medium that stores data semipermanently. Specifically, the aforementioned various applications or programs may be provided in a form stored in the non-transitory readable medium such as a CD, a DVD, a hard disk, a Blu-ray disk, a USB, a memory card, or ROM.

Also, the examples of the disclosure may be implemented as software including instructions stored in the machine-readable storage media, which can be read by the machine (e.g. a computer). The machine refers to a device which calls instructions stored in the storage medium and is operable according to the called instructions, wherein it may include an electronic device (e.g. a robot 100) according to the disclosed embodiments.

If the aforementioned instructions are executed by a processor, the processor may perform a function corresponding to the instructions directly or by using other components under control of the processor. The instructions may include a code generated or executed by a compiler or an interpreter.

As above, preferable examples of the present disclosure are shown and described. However, it is to be understood that the disclosure is not limited to the aforementioned specific examples, and various modifications may be implemented by those skilled in the art without deviating from the gist of the disclosure claimed in the scope of claims. These modifications should not be independently understood from the technical spirit or prospect of the disclosure.

What is claimed is:

1. An oven comprising:
a temperature sensor;
a memory to store risk information including a plurality of risk levels in correspondence with a plurality of temperatures and a plurality of cooking states of the oven; and
one or more processors configured to identify a risk level of the oven, among the plurality of risk levels, corresponding to a cooking state among the plurality of cooking states of the oven and a temperature in a cooking chamber of the oven detected through the temperature sensor based on the risk information stored in the memory and control an opening operation of a door of the oven based on the risk level of the oven,
wherein a speed at which the door is opened and a degree to which the door is opened are determined based on the risk level identified by the one or more processors.

2. The oven of claim 1, wherein the one or more processors are configured to:
identify a recipe mode selected according to a user command among a plurality of recipe modes and identify the risk level corresponding to the cooking state of the oven and the temperature in the cooking chamber detected through the temperature sensor based on risk information corresponding to the recipe mode.

3. The oven of claim 1, wherein the one or more processors are configured to:
identify the speed at which the door is opened and the degree to which the door is opened corresponding to the risk level of the oven among opening speeds of the door and opening degrees of the door corresponding to the plurality of risk levels and open the door according to the identified speed and degree.

4. The oven of claim 3, wherein the one or more processors are configured to:
based on the risk level of the oven being in a first risk level among the plurality of risk levels, open the door at a first speed;
based on the risk level of the oven being in a second risk level higher than the first risk level among the plurality of risk levels, open the door at a second speed lower than the first speed;
based on the risk level of the oven being in a third risk level higher than the second risk level among the plurality of risk levels, open the door only partially; and
based on the risk level of the oven being in a fourth risk level higher than the third risk level among the plurality of risk levels, not open the door.

5. The oven of claim 1, further comprising:
a light emitting element,
wherein the one or more processors are configured to:
control the light emitting element to emit a color corresponding to the risk level of the oven among a plurality of different colors corresponding to the plurality of risk levels.

6. The oven of claim 5, wherein light emitted by the light emitting element is displayed on door glass of the door.

7. The oven of claim 1, further comprising:
a speaker,
wherein the one or more processors are configured to:
based on the risk level of the oven being equal to or greater than a preset risk level, output sound through the speaker.

8. The oven of claim 1, further comprising:
a camera; and
a speaker,
wherein the one or more processors are configured to:
based on the door being opened and the risk level of the oven being equal to or greater than a preset risk level, obtain an image where the cooking chamber is photographed by using the camera, and
based on a hand of a user without a glove being identified in the obtained image, output sound through the speaker.

9. A method of controlling an oven, comprising:
identifying a risk level of the oven corresponding to a cooking state of the oven and a temperature in a cooking chamber of the oven based on risk information; and
controlling an opening operation of a door of the oven based on the risk level of the oven,
wherein the risk information a plurality of risk levels in correspondence with a plurality of temperatures and a plurality of cooking states of the oven, and
wherein a speed at which the door is opened and a degree to the door is opened are determined based on the risk level.

10. The method of controlling the oven of claim 9, wherein the identifying includes:
identifying a recipe mode selected according to a user command among a plurality of recipe modes and identifying the risk level corresponding to the cooking state of the oven and the temperature in the cooking chamber based on risk information corresponding to the recipe mode.

11. The method of controlling the oven of claim 9, wherein the controlling includes:
identifying the speed at which the door is opened and the degree to which the door is opened corresponding to the risk level of the oven among opening speeds of the door and opening degrees of the door corresponding to each of a plurality of risk levels and opening the door according to the identified opening speed and opening degree.

12. The method of controlling the oven of claim 11, wherein the controlling includes:
based on the risk level of the oven being in a first risk level among the plurality of risk levels, opening the door at a first speed;
based on the risk level of the oven being in a second risk level higher than the first risk level among the plurality of risk levels, opening the door at a second speed lower than the first speed;
based on the risk level of the oven being in a third risk level higher than the second risk level among the plurality of risk levels, opening the door only partially; and
based on the risk level of the oven being in a fourth risk level higher than the third risk level among the plurality of risk levels, not opening the door.

13. The method of controlling the oven of claim 9, further comprising:
emitting a color corresponding to the risk level of the oven among a plurality of different colors corresponding to the plurality of risk levels by using a light emitting element.

14. The method of controlling the oven of claim 13, wherein light emitted by the light emitting element is displayed on door glass of the door.

15. The method of controlling the oven of claim 9, further comprising:
based on the risk level of the oven being equal to or greater than a preset risk level, outputting sound.

16. The method of controlling the oven of claim 9, further comprising:
based on the door being opened and the risk level of the oven being equal to or greater than a preset risk level, obtaining an image where the cooking chamber is photographed; and
based on a hand of a user without a glove being identified in the obtained image, outputting sound.

17. A non-transitory computer readable recording medium storing computer instructions that cause an oven to perform an operation when executed by one or more processors of the oven, wherein the operation comprises;
identifying a risk level of the oven corresponding to a cooking state of the oven and a temperature in a cooking chamber of the oven based on risk information; and
controlling an opening operation of a door of the oven based on the risk level of the oven,
wherein the risk information a plurality of risk levels in correspondence with a plurality of temperatures and a plurality of cooking states of the oven, and
wherein a speed at which the door is opened and a degree to the door is opened are determined based on the risk level.

18. The medium of claim 17, wherein the identifying includes:
identifying a recipe mode selected according to a user command among a plurality of recipe modes and identifying the risk level corresponding to the cooking state of the oven and the temperature in the cooking chamber based on risk information corresponding to the recipe mode.

19. The medium of claim 17, wherein the controlling includes:
identifying the speed at which the door is opened and the degree to which the door is opened corresponding to the risk level of the oven among opening speeds of the door and opening degrees of the door corresponding to each of a plurality of risk levels and opening the door according to the identified opening speed and opening degree.

20. The medium of claim 19, wherein the controlling includes:
based on the risk level of the oven being in a first risk level among the plurality of risk levels, opening the door at a first speed;
based on the risk level of the oven being in a second risk level higher than the first risk level among the plurality of risk levels, opening the door at a second speed lower than the first speed;
based on the risk level of the oven being in a third risk level higher than the second risk level among the plurality of risk levels, opening the door only partially; and
based on the risk level of the oven being in a fourth risk level higher than the third risk level among the plurality of risk levels, not opening the door.
